(19) United States
(12) Patent Application Publication
(10) Pub. No.: US 2024/0236222 A9
(43) Pub. Date: Jul. 11, 2024

(54) SUPPORTING STRUCTURE AND MOBILE PHONE CASE THEREOF

(71) Applicant: GUANGZHOU TOKO TECHNOLOGY LIMITED, Guangzhou (CN)

(72) Inventor: Dani BOTERASHEVILI, Guangzhou (CN)

(21) Appl. No.: 18/312,824

(22) Filed: May 5, 2023

(30) Foreign Application Priority Data
Oct. 19, 2022 (CN) 202222759972.1

(51) Int. Cl. H04M 1/04

(52) U.S. Cl. CPC H04M 1/04

(57) ABSTRACT

The invention discloses a supporting structure comprising: a base, the base being provided with a sliding track; and a supporting element slidably disposed within the sliding track, wherein the supporting element is provided with a pivoting portion, and a sliding stopping portion is disposed within the sliding track. To stand a mobile phone on its side to watch or operate, the supporting element is extracted from the base, and then the supporting element is pulled to flip to a preset supporting angle in relation to the base such that the supporting element is inclined in relation to the mobile-phone carrying device. Therefore, the mobile-phone carrying device maintains a side-standing state without a hand-holding condition. To storage, the supporting element is pulled in opposite direction to an angle which is aligned to the sliding track in relation to the base, and then, the supporting element is pushed into the sliding track.

### FIELD OF THE INVENTION

The present invention relates to a supporting structure and a mobile phone case thereof.

### BACKGROUND OF THE INVENTION

With the development of communications technology, intelligent terminals such as smart phones have become indispensable devices for people's lives. In order to protect a mobile phone from collisions, a user usually covers the mobile phone with a mobile phone case or disposes the mobile phone on a mobile phone supporting structure. To free up the user's hands and fix the mobile phone in a side-standing state, it is known that some existing mobile phone cases have the function of side-standing. However, the existing mobile phone cases with the side-standing function have a defect that they occupy large space, which brings inconveniences to the user.

### SUMMARY OF THE INVENTION

Therefore, to solve at least one of the problems existing in the above mentioned prior art, according to one aspect of the present invention a supporting structure is provided comprising: a base which can be disposed on a mobile-phone carrying device, the base being provided with a sliding track; and a supporting element slidably disposed within the sliding track, wherein the supporting element is provided with a pivoting portion, and a sliding stopping portion is disposed within the sliding track such that after the supporting element is pulled out from the base, the pivoting portion will be blocked by the sliding stopping portion, and the supporting element will be driven by an external force to flip to a preset supporting angle in relation to the base by the pivoting portion.

Substantial operating principle: the supporting structure is attached to the mobile-phone carrying device when in use, or formed integrally with the mobile-phone carrying device during manufacture. Then a mobile phone is mounted on the mobile-phone carrying device. When a user intends to stand the mobile phone on its side in use, the supporting element of the supporting structure is extracted from the base, and the pivoting portion will be blocked by the sliding stopping portion to stop the pivoting portion being extracted from the sliding track. The user then pulls the supporting element to flip to the preset supporting angle in relation to the base such that the supporting element is inclined in relation to both the mobile-phone carrying device and the mobile phone. The user then props the supporting element to stand on a desktop such that the mobile-phone carrying device and the mobile phone maintain a side-standing state without hand holding. It thus is easy for users to use. When the user needs to retract the supporting element to the supporting structure, the user pulls the supporting element in opposite direction to flip to an angle which is aligned with the sliding track in relation to the base, and then pushes the supporting element into the sliding track to reduce the volume and facilitate portability and storage. The mobile-phone carrying device of the present invention has features of easy to carry, small space occupation and compact structure, which facilitates miniaturization, light weight and thin design for the mobile-phone carrying device.

In one embodiment of the present invention, the base further comprises: a base plate and a covering plate, the sliding track is disposed on the base plate, and the covering plate covers the sliding track.

In this way, the base plate and the covering plate which are enclosed together to form the sliding track can be manufactured separately to facilitate processing and to improve production efficiency as well.

In one embodiment of the present invention, the sliding track is provided as a recessed space formed in the base plate, the covering plate is embedded in the sliding track such that the covering plate is aligned with the base plate.

In this way, by embedding the covering plate in the sliding track, the covering plate is aligned with the base plate, enabling a thin design of the supporting structure.

In one embodiment of the present invention, the pivoting portion is provided as a rotating shaft formed on a first end of the supporting element, the rotating shaft extends outwardly with respect to the first end, the sliding stopping portion is provided as a blocking section formed in a terminal end of the sliding track, and the blocking section has a length less than that of the rotating shaft such that the rotating shaft is confined within the sliding track and not removed from the sliding track.

In this way, since the length of the blocking section is less than the length of the rotating shaft, when the supporting element is extracted and the pivoting portion is moved to the blocking section, the pivoting portion cannot pass through the blocking section, and the rotating shaft is confined within the sliding track and not removed from the sliding track.

In one embodiment of the present invention, the covering plate is provided with a stopping block, the stopping block protrudes into the terminal end of the sliding track, and the stopping block and the extremity of the sliding track enclose together to form the blocking section.

In this way, when the supporting element is extracted and the pivoting portion is moved to the blocking section, the stopping block blocks the rotating shaft to stop the supporting element moving, which prevents the supporting element and the sliding track from detaching.

In one embodiment of the present invention, a stable supporting plate is disposed on a second end of the supporting element, and the stable supporting plate is arranged perpendicular to the supporting element.

In this way, when the supporting element is standing on the desktop, the stable supporting plate provides support for the supporting element from two sides to prevent the supporting element from swaying from side to side such that the mobile-phone carrying device and the mobile phone are more stable to maintain the side-standing state.

In one embodiment of the present invention, a recessed area is disposed on an outer side of the base, the sliding track extends to the recessed area to form a supporting stair on the outer side of the base for limiting the flipping angle of the supporting element.

In this way, when the user pulls the supporting element to flip to the preset supporting angle in relation to the base, the supporting stair abuts against the supporting element to prevent the supporting element from flipping such that the supporting element stands on the desktop.

In one embodiment of the present invention, the covering plate is provided with an avoidance area which is an area for flipping the rotating shaft, the rotating shaft is configured to a flat head shape such that when the supporting element is flipped to the preset supporting angle in relation to the base, the rotating shaft and the covering plate produce an elastic compression to increase a static friction between the rotating shaft and the covering plate.

In this way, when the user pulls the supporting element to flip in relation to the base, the rotating shaft can freely rotate since the space size of the avoidance area is larger than the size of the rotating shaft, providing convenience for the user to pull the supporting element. When the supporting element is close to or about to flip to the preset supporting angle, a big size position of the rotating shaft flip to abut against the covering plate such that the rotating shaft and the covering plate produce the elastic compression to increase the static friction between the rotating shaft and the covering plate, the static friction prevents the supporting element from freely rotating. When the user picks up the mobile-phone carrying device of the present invention, the supporting element still maintains the preset supporting angle such that when the user puts down the mobile-phone carrying device, the supporting element can still support the mobile-phone carrying device to maintain the side-standing state.

Another objective of the present invention is to provide a mobile phone case comprising: the supporting structure mentioned above and a case, the base is disposed on the case, or the base is integrally formed with the case.

In usage, the mobile phone is mounted on the mobile phone case. Accordingly, when the user intends to stand a mobile phone on its side, the supporting element of the supporting structure is extracted from the base, and the pivoting portion is blocked by the sliding stopping portion to prevent the pivoting portion from being extracted from the sliding track. Then, the user pulls the supporting element to flip to the preset supporting angle in relation to the base such that the supporting element is inclined in relation to the mobile phone case. Then, the user props the supporting element to stand on a desktop such that the mobile phone case and the mobile phone maintain a side-standing state without hand holding. Thus it becomes easy for the user to operate or watch the mobile phone. When the user needs to retract the supporting element to the supporting structure, the user pulls the supporting element in opposite direction to flip to an angle which is aligned with the sliding track in relation to the base, and then pushes the supporting element into the sliding track to reduce the volume and facilitate portability and storage. The mobile phone case has features of easy to carry, small space occupation and compact structure, which facilitates miniaturization, light weight and thin design for the mobile phone case.

In some preferred embodiments, the case is further provided with an elastic wristband.

In this way, it is easy for the user to carry or hold the mobile phone case through the elastic wristband, which improves the product experience.

### BRIEF DESCRIPTION OF THE DRAWINGS

FIG. 1 is a schematic diagram illustrating a supporting structure of one embodiment of the present invention;

FIG. 2 is an exploded schematic diagram of the supporting structure as shown in FIG. 1;

FIG. 3 is a schematic diagram illustrating the supporting element and the base plate in FIG. 2;

FIG. 4 is a schematic diagram illustrating the covering plate in FIG. 2;

FIG. 5 is a schematic diagram illustrating the supporting element in FIG. 1 being extracted from the base;

FIG. 6 is a schematic diagram illustrating the supporting element in FIG. 5 flipped to the present supporting angle in relation to the base;

FIG. 7 is an exploded schematic diagram of the mobile phone case of the supporting structure as shown in FIG. 1;

FIG. 8 is a schematic diagram illustrating the supporting element in FIG. 7 being extracted from the base;

FIG. 9 is a schematic diagram illustrating the supporting element in FIG. 8 flipped to the preset supporting angle in relation to the base;

FIG. 10 is a schematic diagram illustrating the mobile phone case shown in FIG. 9 maintained the slide standing state; and

FIG. 11 is a schematic diagram illustrating the mobile phone case of the supporting structure in FIG. 1 with the elastic wristband attached.

### DETAILED DESCRIPTION OF THE PREFERRED EMBODIMENTS

It should be noted that the embodiments and the features of the present invention can be combined with each other without conflict.

It also should be noted that in this description, relationship terms such as “first” and “second” are only used to distinguish one entity or operation from another, and do not necessarily require or imply any actual relationship or sequence among these entities or operations. Moreover, the terms “include” and “comprise” include not only those factors, but also other factors which are not explicitly listed or the inherent factors belonging to such process, method, article or equipment. Without further restrictions, the factors defined by the phrase “includes . . . ” do not exclude the existence of additional identical factors in the process, the method, the article or the equipment. The terms used herein are generally those commonly used by the person skilled in the art, and in the event of inconsistency with commonly used terms, the terms used herein shall prevail. In order to make the purpose, technical manners and advantages of the embodiments of the present invention clearer, the technical manners in the embodiments of the present invention will be clearly and completely described below in conjunction with the accompanying drawings in the embodiments of the present invention. Obviously, the described embodiments are a part of the embodiments of the present invention but not all of them. Based on the embodiments in the present invention, all other embodiments obtained by the person skilled in the art without making creative labor fall within the scope of protection of the present invention.

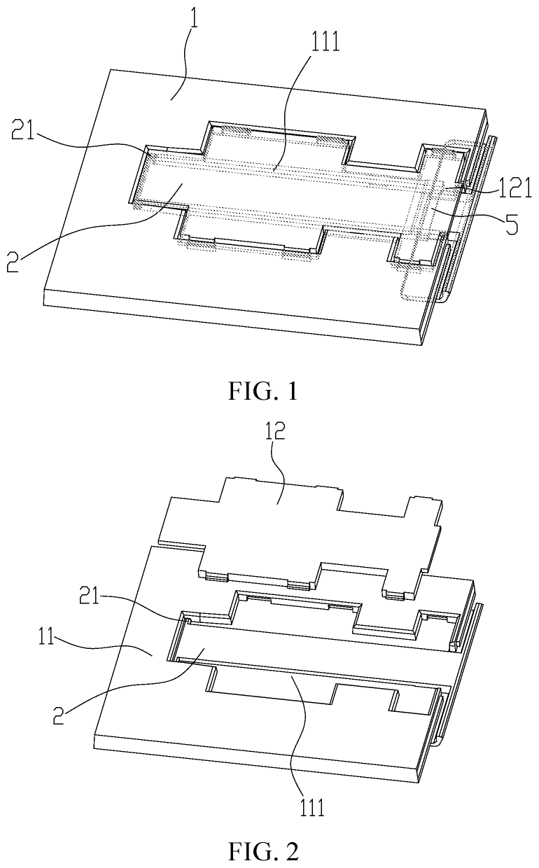

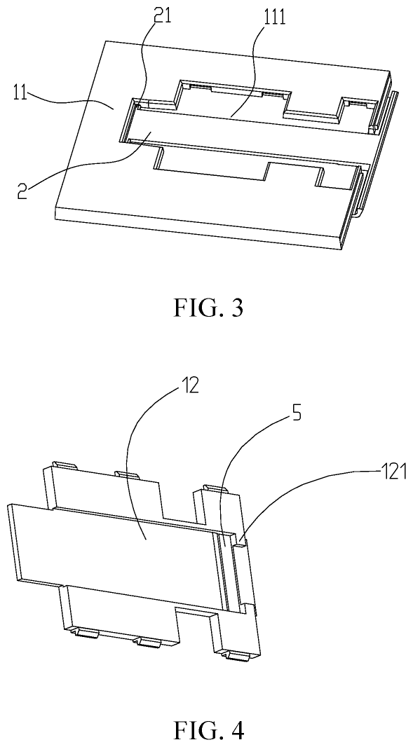

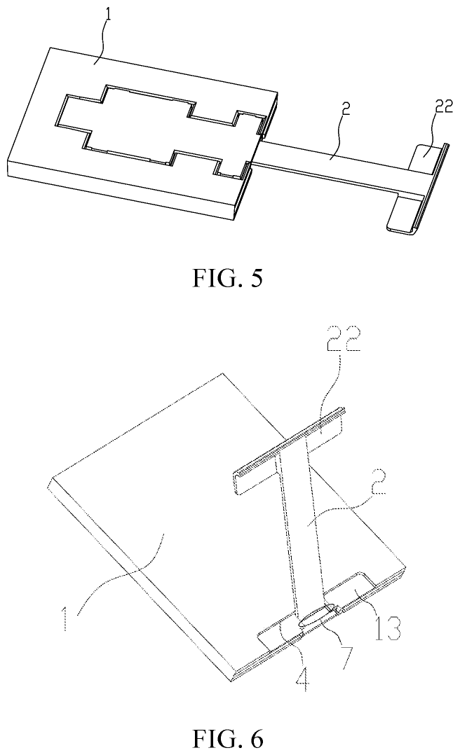

FIGS. 1 to 6 schematically show a supporting structure according to one embodiment of the present invention.

As shown in FIGS. 1 to 6, the supporting structure comprises: a base 1 which can be disposed on a mobile-phone carrying device, the base 1 being provided with a sliding track 111; and a supporting element 2 slidably disposed within the sliding track 111, wherein the supporting element 2 is provided with a pivoting portion 21, and a sliding stopping portion 7 is disposed within the sliding track 111 such that after the supporting element 2 is pulled out from the base 1, the pivoting portion 21 will be blocked by the sliding stopping portion 7, and the supporting element 2 will be driven by an external force to flip to a preset supporting angle in relation to the base 1 by the pivoting portion 21. In detail, the supporting structure can be applied in the mobile-phone carrying device such as a mobile phone holder or a mobile phone case. The specific application scenarios of the supporting structure can be adapted according to the actual situation.

Substantial operating principle: the supporting structure is attached to the mobile-phone carrying device during use or formed integrally with the mobile-phone carrying device during manufacture. Then a mobile phone is mounted on the mobile-phone carrying device. When a user intends to stand the mobile phone on its side in use, the supporting element 2 of the supporting structure is extracted from the base 1, and the pivoting portion 21 will be blocked by the sliding stopping portion 7 to stop the pivoting portion 21 being extracted from the sliding track 111. The user then pulls the supporting element 2 to flip to the preset supporting angle in relation to the base 1 such that the supporting element 2 is inclined in relation to both the mobile-phone carrying device and the mobile phone. The user then props the supporting element 2 to stand on a desktop such that the mobile-phone carrying device and the mobile phone maintain a side-standing state without hand holding. It thus is easy for users to use. When the user needs to retract the supporting element 2 to the supporting structure, the user pulls the supporting element 2 in opposite direction to flip to an angle which is aligned with the sliding track 111 in relation to the base 1, and then pushes the supporting element 2 into the sliding track 111 to reduce the volume and facilitate portability and storage. The mobile-phone carrying device of the present invention has features of easy to carry, small space occupation and compact structure, which facilitates miniaturization, light weight and thin design for the mobile-phone carrying device.

In the embodiment, the base 1 comprises: a base plate 11 and a covering plate 12, the sliding track 111 is disposed on the base plate 11, and the covering plate 12 covers the sliding track 111. In this way, the base plate 11 and the covering plate 12 which are enclosed together to form the sliding track 111 can be manufactured separately to facilitate processing and to improve production efficiency as well.

In the embodiment, the sliding track 111 is provided as a recessed space formed in the base plate 11, the covering plate 12 is embedded in the sliding track 111 such that the covering plate 12 is aligned with the base plate 11. In this way, by embedding the covering plate 12 in the sliding track 111, the covering plate 12 is aligned with the base plate 11, enabling a thin design of the supporting structure.

In the embodiment, the pivoting portion 21 is provided as a rotating shaft formed on a first end of the supporting element 2, the rotating shaft extends outwardly with respect to the first end, the sliding stopping portion 7 is provided as a blocking section formed in a terminal end of the sliding track 111, and the blocking section has a length less than that of the rotating shaft such that the rotating shaft is confined within the sliding track 111 and not removed from the sliding track 111. In other preferred embodiments, The specific form and structure of the pivoting part 21 can be adapted to the actual situation, i.e., as long as the pivoting part 21 can support the support member 2 to flip to the preset supporting angle in relation to the base 1. In this way, since the length of the blocking section is less than the length of the rotating shaft, when the supporting element 2 is extracted and the pivoting portion 21 is moved to the blocking section, the pivoting portion 21 cannot pass through the blocking section, and the rotating shaft is confined within the sliding track 111 and not removed from the sliding track 111.

In the embodiment, the covering plate 12 is provided with a stopping block 121, the stopping block 121 protrudes into the terminal end of the sliding track 111, and the stopping block 121 and the extremity of the sliding track 111 enclose together to form the blocking section. In this way, when the supporting element 2 is extracted and the pivoting portion 21 is moved to the blocking section, the stopping block 121 blocks the rotating shaft to stop the supporting element 2 moving, which prevents the supporting element 2 and the sliding track 111 from detaching.

In the embodiment, a stable supporting plate 22 is disposed on a second end of the supporting element 2, and the stable supporting plate 22 is arranged perpendicular to the supporting element 2. In detail, the second end of the supporting member 2 is provided in the middle position of the stable supporting plate 22, and the stable supporting plate 22 is a sheet shape. In this way, when the supporting element 2 is standing on the desktop, the stable supporting plate 22 provides support for the supporting element 2 from two sides to prevent the supporting element 2 from swaying from side to side such that the mobile-phone carrying device and the mobile phone are more stable to maintain the side-standing state.

In the embodiment, a recessed area 13 is disposed on an outer side of the base 1, the sliding track 111 extends to the recessed area 13 to form a supporting stair 4 on the outer side of the base 1 for limiting the flipping angle of the supporting element. In this way, when the user pulls the supporting element 2 to flip to the preset supporting angle in relation to the base 1, the supporting stair 4 abuts against the supporting element 2 to prevent the supporting element 2 from flipping such that the supporting element 2 stands on the desktop.

In the embodiment, the covering plate 12 is provided with an avoidance area which is an area for flipping the rotating shaft, the rotating shaft is configured to a flat head shape such that when the supporting element 2 is flipped to the preset supporting angle in relation to the base 1, the rotating shaft and the covering plate 12 produce an elastic compression to increase a static friction between the rotating shaft and the covering plate 12. In this way, when the user pulls the supporting element 2 to flip in relation to the base 1, the rotating shaft can freely rotate since the space size of the avoidance area 5 is larger than the size of the rotating shaft, providing convenience for the user to pull the supporting element 2. When the supporting element 2 is close to or about to flip to the preset supporting angle, a big size position of the rotating shaft abuts against the covering plate 12 such that the rotating shaft and the covering plate 12 produce the elastic compression to increase the static friction between the rotating shaft and the covering plate 12, the static friction prevents the supporting element 2 from freely rotating. When the user picks up the mobile-phone carrying device of the present invention, the supporting element 2 still maintains the preset supporting angle such that when the user puts down the mobile-phone carrying device, the supporting element 2 can still support the mobile-phone carrying device to maintain the side-standing state.

### Second Embodiment

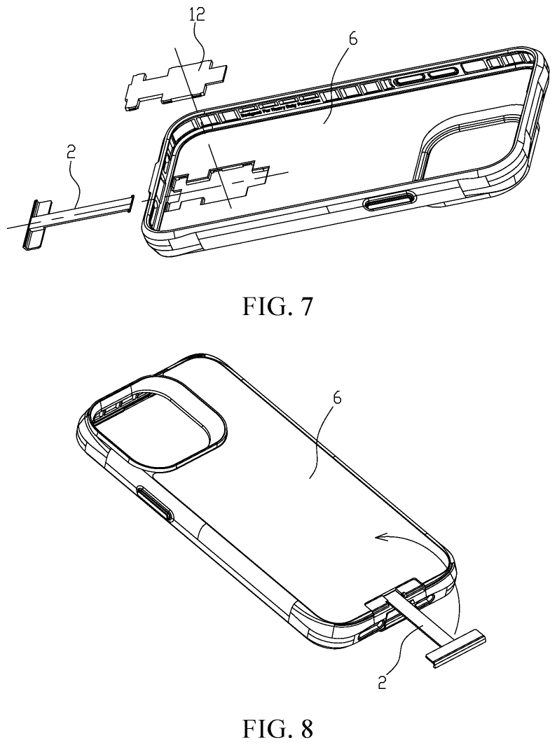

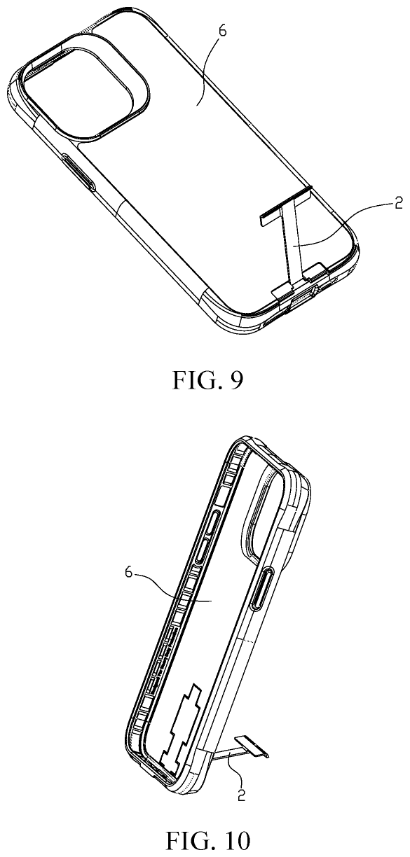

As shown in FIGS. 7 to 10, another objective of the present invention is to provide a mobile phone case comprising: the supporting structure of first embodiment mentioned above and a case 6, the base 1 is integrally formed with the case 6. In other preferred embodiments, the specific way and form of the connection between the base 1 and the case 6 can also be adapted to the actual situation. For example, the base 1 may also be connected to the case 6 by riveting, bonding, snap-fitting, gluing, and magnetic connection.

In usage, the mobile phone is mounted on the mobile phone case Accordingly, when the user intends to stand a mobile phone on its side, the supporting element 2 of the supporting structure is extracted from the base 1, and the pivoting portion 21 is blocked by the sliding stopping portion to prevent the pivoting portion 21 from being extracted from the sliding track 111. Then, the user pulls the supporting element 2 to flip to the preset supporting angle in relation to the base 1 such that the supporting element 2 is inclined in relation to the mobile phone case. Then, the user props the supporting element 2 to stand on a desktop such that the mobile phone case and the mobile phone maintain a side-standing state without hand holding. Thus it becomes easy for the user to operate or watch the mobile phone. When the user needs to retract the supporting element 2 to the supporting structure, the user pulls the supporting element 2 in opposite direction to flip to an angle which is aligned with the sliding track 111 in relation to the base 1, and then pushes the supporting element 2 into the sliding track 111 to reduce the volume and facilitate portability and storage. The mobile phone case has features of easy to carry, small space occupation and compact structure, which facilitates miniaturization, light weight and thin design for the mobile phone case.

Further in detail, an inner surface of the case 6 for contacting with the back surface of the mobile phone is provided with an anti-scratch layer which is used to cover the supporting structure, while the supporting structure can be prevented from scratching the back surface of the mobile phone. In detail, the material of the anti-scratch layer can be a fleece layer, and the fleece layer is pasted on the inner surface of the case 6.

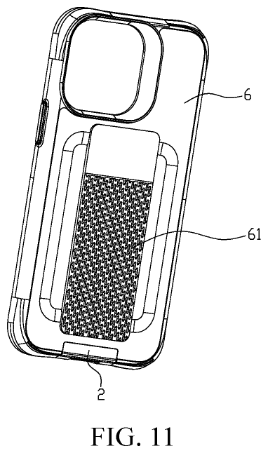

As shown in FIG. 11, in the embodiment, the case 6 is further provided with an elastic wristband 61. In this way, it is easy for the user to carry or hold the mobile phone case by the elastic wristband 61, which improves the product experience.

The descriptions mentioned above are only some embodiments of the present invention. For the person skilled in the art, a number of variations and improvements can be made without departing from the creative conception of the present invention, which are within the protection scope of the present invention.

What is claimed is:

1. A supporting structure characterized in that the supporting structure comprises:
a base, the base being provided with a sliding track; and
a supporting element slidably disposed within the sliding track, wherein the supporting element is provided with a pivoting portion, and a sliding stopping portion is disposed within the sliding track such that after the supporting element is pulled out from the base, the pivoting portion will be blocked by the sliding stopping portion, and the supporting element will be driven by an external force to flip to a preset supporting angle in relation to the base by the pivoting portion.

2. The supporting structure as claimed in claim 1, characterized in that the base further comprises: a base plate and a covering plate, the sliding track is disposed on the base plate, and the covering plate covers the sliding track.

3. The supporting structure as claimed in claim 2, characterized in that the sliding track is provided as a recessed space formed in the base plate, the covering plate is embedded in the sliding track such that the covering plate is aligned with the base plate.

4. The supporting structure as claimed in claim 2, characterized in that the pivoting portion is provided as a rotating shaft formed on a first end of the supporting element, the rotating shaft extends outwardly with respect to the first end, the sliding stopping portion is provided as a blocking section formed in a terminal end of the sliding track, and the blocking section has a length less than that of the rotating shaft such that the rotating shaft is confined within the sliding track and not removed from the sliding track.

5. The supporting structure as claimed in claim 4, characterized in that the covering plate is provided with a stopping block, the stopping block protrudes into the terminal end of the sliding track, and the stopping block and the extremity of the sliding track enclose together to form the blocking section.

6. The supporting structure as claimed in claim 1, characterized in that a stable supporting plate is disposed on a second end of the supporting element, and the stable supporting plate is arranged perpendicular to the supporting element.

7. The supporting structure as claimed in claim 1, characterized in that a recessed area is disposed on an outer side of the base, the sliding track extends to the recessed area to form a supporting stair on the outer side of the base for limiting the flipping angle of the supporting element.

8. The supporting structure as claimed in claim 4, characterized in that the covering plate is provided with an avoidance area which is an area for flipping the rotating shaft, the rotating shaft is configured to a flat head shape such that when the supporting element is flipped to the preset supporting angle in relation to the base, the rotating shaft and the covering plate produce an elastic compression to increase a static friction between the rotating shaft and the covering plate.

9. A mobile phone case, characterized in that the mobile phone case comprises: the supporting structure as claimed in claim 1 and a case, the base is disposed on the case, or the base is integrally formed with the case.

10. The mobile phone case as claimed in claim 9, characterized in that the base further comprises: a base plate and a covering plate, the sliding track is disposed on the base plate, and the covering plate covers the sliding track.

11. The mobile phone case as claimed in claim 10, characterized in that the sliding track is provided as a recessed space formed in the base plate, the covering plate is embedded in the sliding track such that the covering plate is aligned with the base plate.

12. The mobile phone case as claimed in claim 10, characterized in that the pivoting portion is provided as a rotating shaft formed on a first end of the supporting element, the rotating shaft extends outwardly with respect to the first end, the sliding stopping portion is provided as a blocking section formed in a terminal end of the sliding track, and the blocking section has a length less than that of the rotating shaft such that the rotating shaft is confined within the sliding track and not removed from the sliding track.

13. The mobile phone case as claimed in claim 12, characterized in that the covering plate is provided with a stopping block, the stopping block protrudes into the terminal end of the sliding track, and the stopping block and the extremity of the sliding track enclose together to form the blocking section.

14. The mobile phone case as claimed in claim 9, characterized in that a stable supporting plate is disposed on a second end of the supporting element, and the stable supporting plate is arranged perpendicular to the supporting element.

15. The mobile phone case as claimed in claim 9, characterized in that a recessed area is disposed on an outer side of the base, the sliding track extends to the recessed area to form a supporting stair on the outer side of the base for limiting the flipping angle of the supporting element.

16. The mobile phone case as claimed in claim 12, characterized in that the covering plate is provided with an avoidance area which is an area for flipping the rotating shaft, the rotating shaft is configured to a flat head shape such that when the supporting element is flipped to the preset supporting angle in relation to the base, the rotating shaft and the covering plate produce an elastic compression to increase a static friction between the rotating shaft and the covering plate.

17. The mobile phone case as claimed in claim 9, characterized in that the case is further provided with an elastic wristband.
